(19) United States
(12) Patent Application Publication
(10) Pub. No.: US 2021/0103747 A1
(43) Pub. Date: Apr. 8, 2021

(54) AUDIO-VISUAL AND COOPERATIVE RECOGNITION OF VEHICLES

(71) Applicants: Hassnaa Moustafa, Portland, OR (US); Sathish Kumar Kuttan, San Jose, CA (US); Ying Wei Liew, Penang (MY); Say Chuan Tan, Penang (MY); Chien Chern Yew, Penang (MY)

(72) Inventors: Hassnaa Moustafa, Portland, OR (US); Sathish Kumar Kuttan, San Jose, CA (US); Ying Wei Liew, Penang (MY); Say Chuan Tan, Penang (MY); Chien Chern Yew, Penang (MY)

(21) Appl. No.: 17/125,642

(22) Filed: Dec. 17, 2020

(51) Int. Cl. G06K 9/00; B60W 40/04; G06K 9/62; G06N 3/08

(52) U.S. Cl. CPC G06K 9/00825; G06K 9/00718; B60W 40/04; B60W 2420/54; G06K 9/6218; G06N 3/08; B60W 2420/42; G06K 9/6288

(57) ABSTRACT

A vehicle recognition system includes a sound analysis circuit to analyze captured sounds using an audio machine learning technique to identify a sound event. The system includes an image analysis circuit to analyze captured images using an image machine learning technique to identify an image event, and a vehicle identification circuit to identify a type of vehicle based on the image event and the sound event. The vehicle identification circuit may further use V2V or V2I alerts to identify the type of vehicle and communicate a V2X or V2I alert message based on the vehicle type. In some aspects, the type of vehicle is further identified based on a light event associated with light signals detected by the vehicle recognition system.

### TECHNICAL FIELD

Embodiments described herein generally relate to vehicle recognition systems, and in particular, to a vehicle identification circuit to identify a type of vehicle based on an image event and a sound event.

### BACKGROUND

Each country (or specific geographic location) has different characteristics for specific types of vehicles (e.g., emergency vehicles) and different rules and driving actions to take when in the vicinity of such vehicles.

### BRIEF DESCRIPTION OF THE DRAWINGS

Some embodiments are illustrated by way of example, and not limitation, in the figures of the accompanying drawings in which:

FIG. 1A is a schematic drawing illustrating a system using a vehicle recognition platform to provide emergency vehicle detection based on sound data, light data, and image data, according to an example embodiment;

FIG. 1B is a diagram of separate detection pipelines processing sound data, light data, and image data in the vehicle recognition platform of FIG. 1A, according to an example embodiment;

FIG. 1C is a diagram of convolution neural network (CNN)-based detection pipelines processing sound data and image data in the vehicle recognition platform of FIG. 1A, according to an example embodiment:

FIG. 2 is a diagram illustrating another view of the vehicle recognition platform FIG. 1A, according to an example embodiment;

FIG. 3 is a block diagram illustrating the training of deep learning (DL) model used for vehicle recognition, according to an example embodiment;

FIG. 4 illustrates the structure of a neural network which can be used for vehicle recognition, according to an embodiment:

FIG. 5 illustrates an audio data processing pipeline that can be used in a vehicle recognition platform, according to an example embodiment:

FIG. 6 illustrates an audio data processing pipeline with a signal-to-image conversion which can be used in a vehicle recognition platform, according to an example embodiment;

FIG. 7 illustrates an image data processing pipeline that can be used in a vehicle recognition platform, according to an example embodiment;

FIG. 8 is a flowchart illustrating a method for audiovisual detection correlation and fusion for vehicle recognition, according to an example embodiment;

FIG. 9 illustrates example locations of vehicles during emergency vehicle recognition using the disclosed techniques, according to an example embodiment;

FIG. 10 is a flowchart illustrating a method for transfer learning used in connection with continuous learning by a neural network model used for vehicle recognition, according to an example embodiment;

FIG. 11A and FIG. 11B illustrate V2V and V2I cooperation for emergency vehicle notifications, according to an embodiment;

FIG. 12 is a flowchart illustrating a method for emergency vehicle recognition, according to an example embodiment; and

FIG. 13 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

It is challenging for vehicles (autonomous vehicles, or AVs, not fully autonomous vehicles but equipped with one or more sensor systems, as well as non-autonomous vehicles) to perform a suitable action/reaction in diverse road situations when, for example, emergency vehicles are present. The type and color of the emergency vehicles, the visual lighting alerts and audible alerts emitted by such emergency vehicles, and the signs painted on the emergency vehicles differ from one geographic location to another. Additionally, the meaning of specific alerts (such as law enforcement vehicles with lights turned on) may imply a specific action to be undertaken by surrounding non-emergency vehicles (such as pulling over to the side of the roadway) in one geographic location while it may imply a different action in another geographic location, depending on the local rules. This challenge also exists for human drivers when visiting new countries or geographic locations and when the visual and audible alerts from the emergency vehicles are not visible nor audible inside the driver's vehicle cabin.

In the automotive context, advanced driver assistance systems (ADAS) are those developed to automate, adapt, or enhance vehicle systems to increase safety and provide better driving. In such systems, safety features are designed to avoid collisions and accidents by offering technologies that alert the driver to potential problems or to avoid collisions by implementing safeguards, such as enhanced vehicle recognition, and taking over control of the vehicle (or issuing navigation commands) based on such safeguards (e.g., when an emergency vehicle is detected).

Techniques disclosed herein may be used for accurate recognition of emergency vehicles (e.g., police cars, ambulances, fire trucks) to help AVs, including vehicles with ADAS, to take the appropriate driving action (e.g., clear the way for an ambulance/fire truck and promptly stop for a police vehicle).

ADAS relies on various sensors that can recognize and detect objects and other aspects of their operating environment. Examples of such sensors include visible light cameras, radar, laser scanners (e.g., LiDAR), acoustic (e.g., sonar), and the like. Vehicles may include various forward, sideward, and rearward facing sensor arrays. The sensors may include radar, LiDAR (light imaging detection and ranging), light sensors, cameras for image detection, sound sensors (including microphones or other sound sensors used for vehicle detection such as emergency vehicle detection), ultrasound, infrared, or other sensor systems. Front-facing sensors may be used for adaptive cruise control, parking assistance, lane departure, collision avoidance, pedestrian detection, and the like. Rear-facing sensors may be used to alert the driver of potential obstacles (e.g., vehicles) when performing lane changes or when backing up at slow speeds (e.g., parking distance monitors).

The disclosed techniques present a cooperative audio-visual inference solution to accurately recognize emergency vehicles in diverse geographic locations. The disclosed techniques include one or more of the following functionalities: (a) sound detection of specific audible sirens in addition to object detection of emergency vehicles; (b) detection of lighting patterns emitted by the visual alerts in emergency vehicles (this functionality is especially useful at nights when the visibility is low); (c) multi-modal pipeline(s) operating simultaneously for visual detection and sound detection of emergency vehicles; (d) correlation of the audio and image detection for accurate recognition of emergency vehicles; and (e) Vehicle-to-Vehicle (V2V) and Vehicle-to-Infrastructure (V2I) alerts on emergency vehicles recognized by surrounding vehicles and road side units (RSUs) through audio, visual, and light detections.

Emergency vehicle recognition by AVs and vehicles with ADAS capabilities is mostly performed through audio sensing and acoustic event detection, which can be challenging with distance from the emergency vehicle and in noisy environments. Some solutions apply image recognition to detect emergency vehicles, however, such solutions are complex and require finding multiple patterns in the image to accurately recognize the emergency vehicle in each image region. In this regard, unimodal solutions that use audio or computer vision compromise accuracy of detection in harsh conditions such as poor weather/visibility, lack of line of sight, and noisy roadways compounded by poor weather. Additionally, if the emergency vehicle is not in the field of view of the AV/vehicle with ADAS capabilities, it will be hard to recognize it in time. In comparison, simultaneous multi-modal audio, light, and image inference techniques as discussed herein can aggregate the inference processing, reduce the number of neural networks, and hence the compute necessary, yet provide a higher level of accuracy than unimodal solutions.

The emergency vehicle recognition techniques discussed herein can be used for accurate recognition of emergency vehicles using multi-modal audio/vision/light detection. From a performance perspective, audio and vision pipelines aggregation helps with reducing the processing needed for edge inference in mobile edge architecture implementation use cases. In this regard, autonomous vehicle platforms or road side units (RSUs) may be differentiated and enhanced by making the platform a mobile sensing platform that has a higher level of situational awareness. The value of the platform may be further extended by adding additional sensing capabilities such as collision/accident sensing and recording, air quality monitoring, etc.

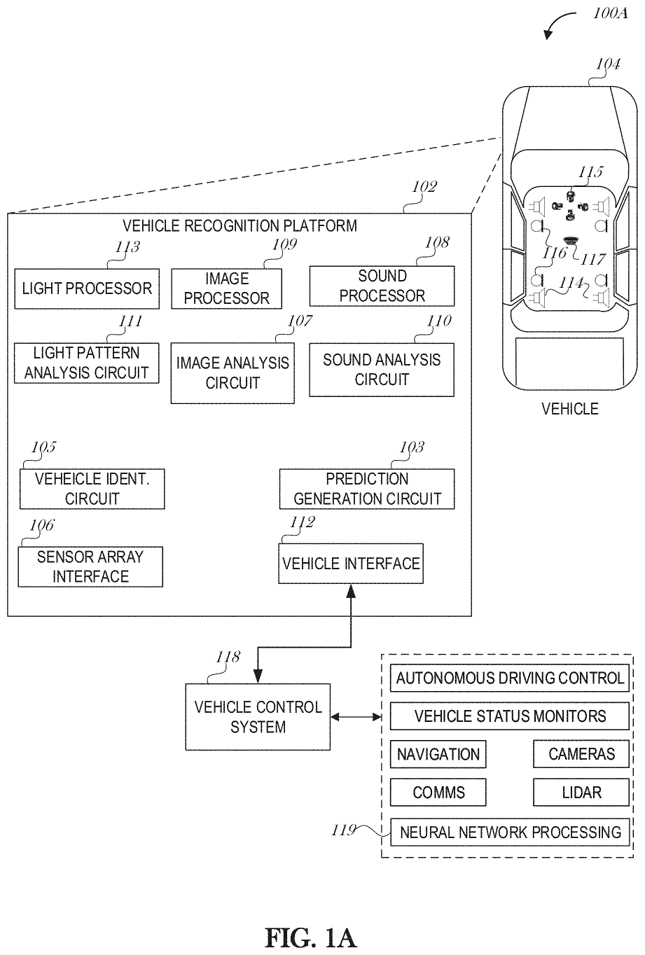

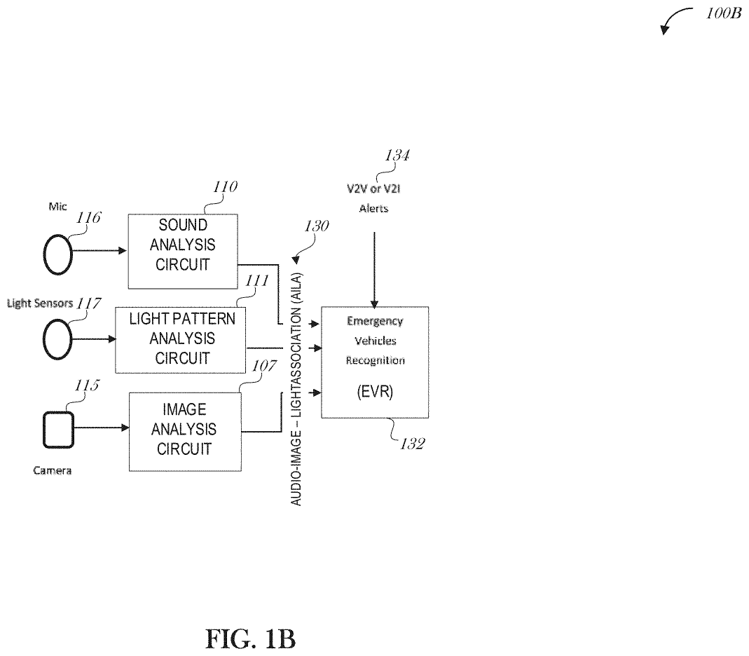

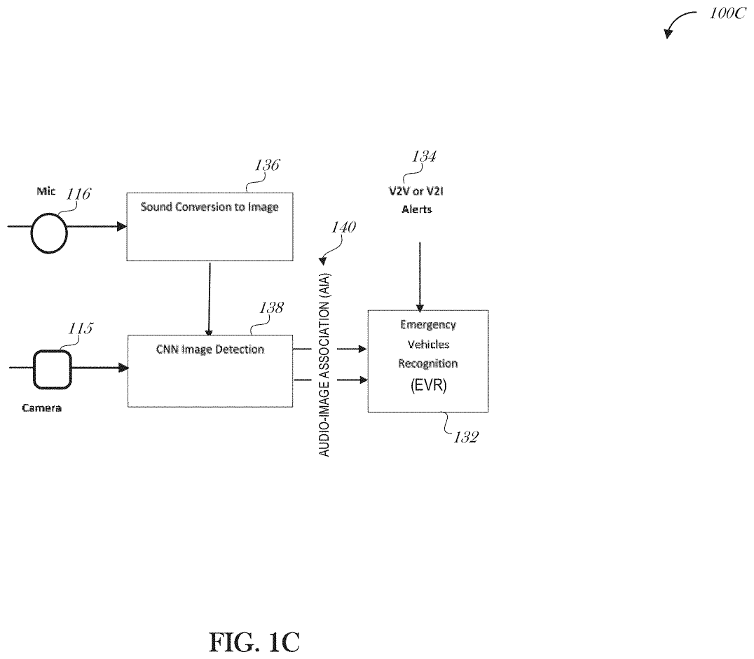

FIG. 1A is a schematic drawing illustrating a system 100A using a vehicle recognition platform to provide emergency vehicle detection based on sound data, light data, and image data, according to an embodiment. FIG. 1A includes a vehicle recognition platform 102 incorporated into vehicle 104. The vehicle recognition platform 102 includes a light processor 113, a light pattern analysis circuit 111, an image processor 109, an image analysis circuit 107, a sound processor 108, a sound analysis circuit 110, a vehicle identification circuit 105, a prediction generation circuit 103, a sensor array interface 106, and a vehicle interface 112.

Vehicle 104, which may also be referred to as an “ego vehicle” or “host vehicle”, may be any type of vehicle, such as a commercial vehicle, a consumer vehicle, a recreation vehicle, a car, a truck, a motorcycle, a boat, a drone, a robot, an airplane, a hovercraft, or any mobile craft able to operate at least partially in an autonomous mode. The vehicle 104 may operate at some times in a manual mode where a driver operates the vehicle 104 conventionally using pedals, a steering wheel, or other controls. At other times, vehicle 104 may operate in a fully autonomous mode, where the vehicle 104 operates without user intervention. In addition, the vehicle 104 may operate in a semiautonomous mode, where the vehicle 104 controls many of the aspects of driving, but the driver may intervene or influence the operation using conventional (e.g., steering wheel) and non-conventional inputs (e.g., voice control).

The vehicle 104 may include one or more speakers 114 that are capable of projecting sound internally as well as externally to the vehicle 104. The vehicle 104 may further include an image capture arrangement 115 (e.g., one or more cameras) and at least one light sensor 117. The speakers 114, the image capture arrangement 115, and the light sensor 117 may be integrated into cavities in the body of the vehicle 104 with covers (e.g., grilles) that are adapted to protect the speaker driver (and other speaker components) and the camera lens from foreign objects, while still allowing sound, images, and light to pass clearly. The grilles may be constructed of plastic, carbon fiber, or other rigid or semi-rigid material that provides structure or weatherproofing to the vehicle's body. The speakers 114, the image capture arrangement 115, and the light sensor 117 may be incorporated into any portion of the vehicle 104. In an embodiment, the speakers 114, the image capture arrangement 115, and the light sensor 117 are installed in the roofline of the vehicle 104, to provide better sound projection as well as image and light reception when the vehicle 104 is amongst other vehicles or other low objects (e.g., while in traffic). The speakers 114, the image capture arrangement 115, and the light sensor 117 may be provided signals through the sensor array interface 106 from the sound processor 108, the image processor 109, and the light processor 113. The sound processor 108 may drive speakers 114 in a coordinated manner to provide directional audio output.

Vehicle 104 may also include a microphone arrangement 116 (e.g., one or more microphones) that are capable of detecting environmental sounds around the vehicle 104. The microphone arrangement 116 may be installed in any portion of the vehicle 104. In an embodiment, the microphone arrangement 116 are installed in the roofline of the vehicle 104. Such placement may provide improved detection capabilities while also reducing ambient background noise (e.g., road and tire noise, exhaust noise, engine noise, etc.). The microphone arrangement 116 may be positioned to have a variable vertical height. Using vertical differentiation allows the microphone arrangement 116 to distinguish sound sources that are above or below the horizontal plane. Variation in the placement of the microphone arrangement 116 may be used to further localize sound sources in three-dimensional space. The microphone arrangement 116 may be controlled by the sound processor 108 in various ways. For instance, the microphone arrangement 116 may be toggled on and off depending on whether the speakers 114 are active and emitting sound, to reduce or eliminate audio feedback. The microphone arrangement 116 may be togged individually, in groups, or all together.

The sensor array interface 106 may be used to provide input or output signals to the vehicle recognition platform 102 from one or more sensors of a sensor array installed on the vehicle 104. Examples of sensors include, but are not limited to microphone arrangement 116; forward, side, or rearward facing cameras such as the image capture arrangement 115; radar; LiDAR; ultrasonic distance measurement sensors; the light sensor 117; or other sensors. Forward-facing or front-facing is used in this document to refer to the primary direction of travel, the direction the seats are arranged to face, the direction of travel when the transmission is set to drive, or the like. Conventionally then, rear-facing or rearward-facing is used to describe sensors that are directed in a roughly opposite direction than those that are forward or front-facing. It is understood that some front-facing camera may have a relatively wide field of view, even up to 180-degrees. Similarly, a rear-facing camera that is directed at an angle (perhaps 60-degrees off-center) to be used to detect traffic in adjacent traffic lanes, may also have a relatively wide field of view, which may overlap the field of view of the front-facing camera. Side-facing sensors are those that are directed outward from the sides of the vehicle 104. Cameras in the sensor array may include infrared or visible light cameras, able to focus at long-range or short-range with narrow or large fields of view. In this regard, the cameras may include a zoom lens, image stabilization, shutter speed, and may be able to automatically adjust aperture or other parameters based on vehicle detection.

Vehicle 104 may also include various other sensors, such as driver identification sensors (e.g., a seat sensor, an eye-tracking, and identification sensor, a fingerprint scanner, a voice recognition module, or the like), occupant sensors, or various environmental sensors to detect wind velocity, outdoor temperature, barometer pressure, rain/moisture, or the like.

Sensor data may be used in a multi-modal fashion as discussed herein to determine the vehicle's operating context, environmental information, road conditions, travel conditions including the presence of other vehicles on the road including emergency vehicles, or the like. The sensor array interface 106 may communicate with another interface, such as an onboard navigation system, of the vehicle 104 to provide or obtain sensor data. Components of the vehicle recognition platform 102 may communicate with components internal to the vehicle recognition platform 102 or components that are external to the platform 102 using a network, which may include local-area networks (LAN), wide-area networks (WAN), wireless networks (e.g., 802.11 or cellular network), ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

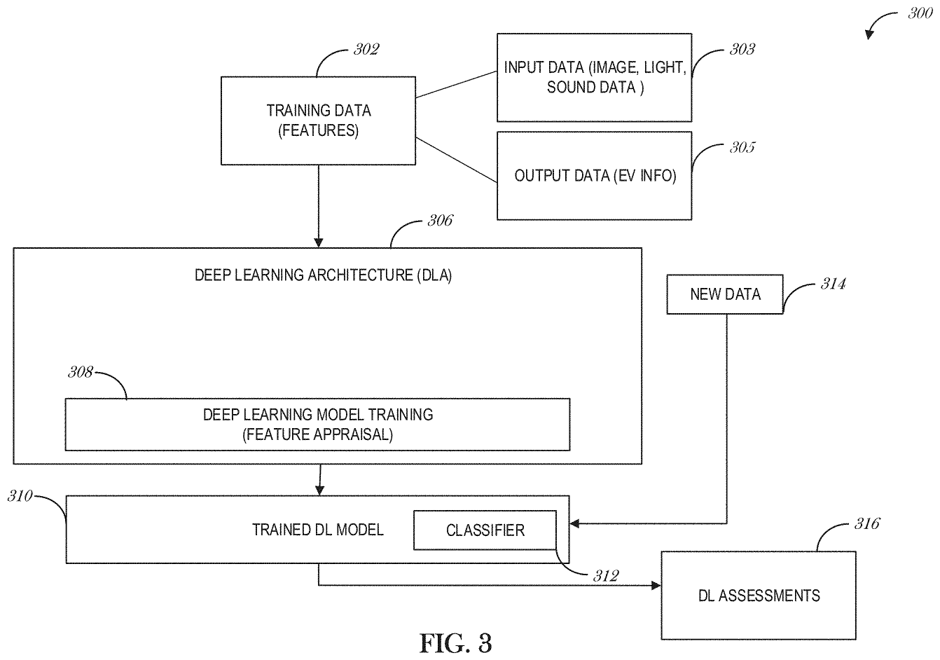

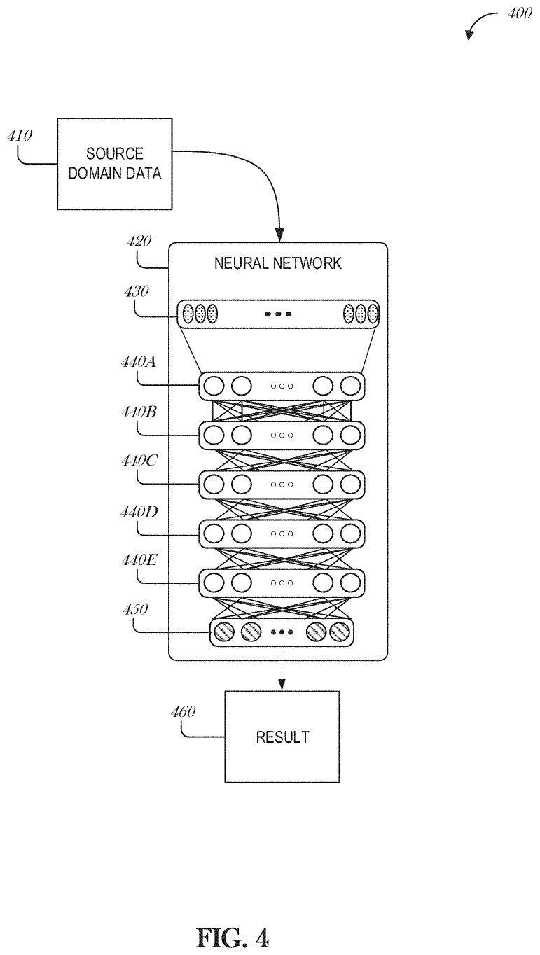

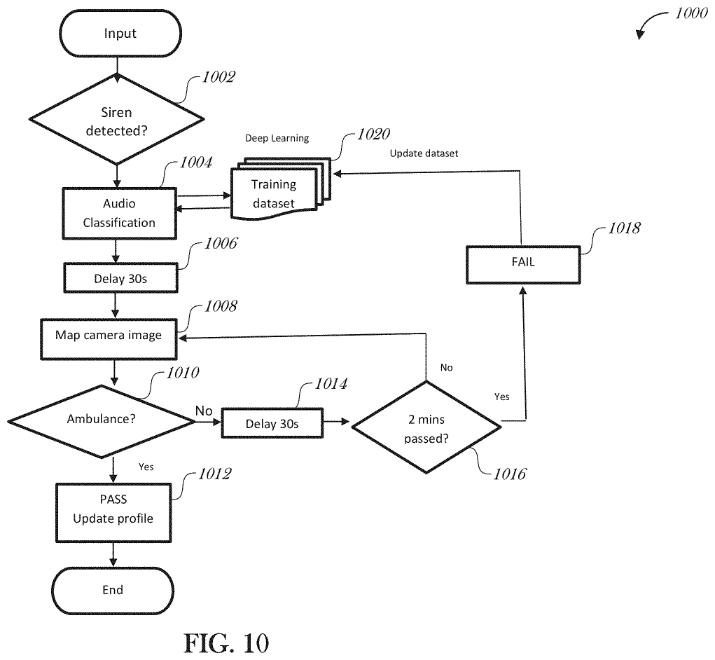

The vehicle recognition platform 102 may communicate with a vehicle control system 118. The vehicle control system 118 may be a component of a larger architecture that controls various aspects of the vehicle's operation. The vehicle control system 118 may have interfaces to autonomous driving control systems (e.g., steering, braking, acceleration, etc.), comfort systems (e.g., heat, air conditioning, seat positioning, etc.), navigation interfaces (e.g., maps and routing systems, positioning systems, etc.), collision avoidance systems, communication systems (e.g., interfaces for vehicle-to-infrastructure, or V2I, and vehicle-to-vehicle, or V2V, communication as well as other types of communications), security systems, vehicle status monitors (e.g., tire pressure monitor, oil level sensor, speedometer, etc.), and the like. Using the vehicle recognition platform 102, the vehicle control system 118 may control one or more subsystems such as the neural network processing subsystem 119 which is used for inferencing using a neural network (e.g., a convolutional neural network or another type of neural network) trained to perform vehicle recognition functionalities discussed herein (e.g., identifying a sound event by the sound analysis circuit 110, identifying an image event by the image analysis circuit 107, and identifying a light event such as detecting a light pattern by the light pattern analysis circuit 11). In some aspects, the neural network processing subsystem may be part of the vehicle identification circuit 105. Example deep learning architecture used for training a machine learning network and a neural network which may be used for vehicle recognition are described in connection with FIG. 3 and FIG. 4. Example transfer learning functions for a machine learning network for purposes of vehicle recognition are discussed in connection with FIG. 10.

Additionally, the vehicle recognition platform 102 may be used in a sensor fusion mechanism with other sensors (e.g., cameras, LiDAR. GPS, light sensors, microphones, etc.), where audio data, image data, and light pattern data are used to augment, corroborate or otherwise assist in vehicle recognition, object type detection, object identification, object position or trajectory determinations, and the like.

Sensor data, such as audio data (e.g., sounds) detected by microphone arrangement 116 installed on or around the vehicle 104, are provided to the sound processor 108 for initial processing. For instance, the sound processor 108 may implement a low-pass filter, a high-pass filter, an amplifier, an analog-to-digital converter, or other audio circuitry in the sound processor 108. The sound processor 108 may also perform feature extraction of the input audio data. Features may then be provided to the sound analysis circuit 110 for identification.

The sound analysis circuit 110 may be constructed using one of several types of machine learning, such as artificial neural networks (ANN), convolutional neural networks (CNN), support vector machines (SVM), Gaussian mixture model (GMM), deep learning, or the like. Using the features provided by the sound processor 108, the sound analysis circuit 110 attempts to analyze the audio data and identify a sound event. In some aspects, the sound event is detecting a sound associated with an emergency vehicle within audio samples (e.g., an audio segment) of the audio data. The sound analysis circuit 110 returns an indication of the sound event, an indication of a detected emergency vehicle, or a possible classification of the emergency vehicle (e.g., an emergency vehicle type such as a police vehicle, an ambulance, a fire truck, etc.) to the sound processor 108 and the vehicle identification circuit 105 for further processing (e.g., to perform an emergency vehicle recognition used for generating and outputting a prediction of an emergency vehicle of a certain type by the prediction generation circuit 103). While the sound analysis circuit 110 is in vehicle 104 in the example shown in FIG. 1A, it is understood that some or all of the classification process may be offboarded, such as at a network-accessible server (e.g., cloud service). For example, feature extraction and vehicle recognition may be performed locally at vehicle 104 to reduce the amount of data to be sent to a cloud service.

Additional sensor data may also be used by the vehicle recognition platform 102 for generating and outputting a prediction of an emergency vehicle. For example, additional sensor data, such as image data detected by the image capture arrangement 115 and light signals detected by the light sensor 117 are provided to the image processor 109 and the light processor 113 respectively for initial processing. For instance, the image processor 109 and the light processor 113 may implement a low-pass filter, a high-pass filter, an amplifier, an analog-to-digital converter, or other audio circuitry in the image processor 109 and the light processor 113. The image processor 109 and the light processor 113 may also perform feature extraction of the input image data and light signals. Features may then be provided to the image analysis circuit 107 and the light pattern analysis circuit 111 for identification.

The image analysis circuit 107 and the light pattern analysis circuit 111 may be constructed using one of several types of machine learning, such as ANN, CNN, SVM, GMM, deep learning, or the like. Using the features provided by the image processor 109 and the light processor 113, the image analysis circuit 107 and the light pattern analysis circuit 111 analyze the image data and light signals to identify an image event and a light event respectively. In some aspects, the image event is detecting a visual representation of an emergency vehicle within at least one image frame associated with the image data. The light event can include a specific light pattern emitted by an emergency vehicle, which light pattern is therefore indicative of a type of emergency vehicle. The image analysis circuit 107 and the light pattern analysis circuit 111 return an indication of the image event and an indication of the light pattern respectively (which can include an indication of a detected emergency vehicle or a possible classification of the emergency vehicle, such as an emergency vehicle type such as a police vehicle, an ambulance, a fire truck, etc.) to the image processor 108, the light processor 113, and the vehicle identification circuit 105 for further processing (e.g., to perform an emergency vehicle recognition used for generating and outputting a prediction of an emergency vehicle of a certain type by the prediction generation circuit 103). While the image analysis circuit 107 and the light pattern analysis circuit 111 are in vehicle 104 in the example shown in FIG. 1A, it is understood that some or all of the classification process may be offboarded, such as at a network-accessible server (e.g., cloud service). For example, feature extraction and vehicle recognition using image data and detected light signals are performed locally at vehicle 104 to reduce the amount of data to be sent to a cloud service.

The vehicle identification circuit 105 comprises suitable circuitry, logic, interfaces, and/or code and is configured to receive the sound event from the sound analysis circuit 110, the image event from the image analysis circuit 107, and a light event from the light pattern analysis circuit 111, perform an emergency vehicle recognition based on an audio-image association or audio-image-light association generated based on the received multimodal event data. The prediction generation circuit 103 generates a prediction of an emergency vehicle of a certain type based on the emergency vehicle recognition (e.g., recognition of a vehicle type) performed by the vehicle identification circuit 105. One or more responsive activities may be generated by the vehicle recognition platform 102 in response to the emergency vehicle prediction. In an example embodiment, the prediction generation circuit is part of the vehicle identification circuit 105.

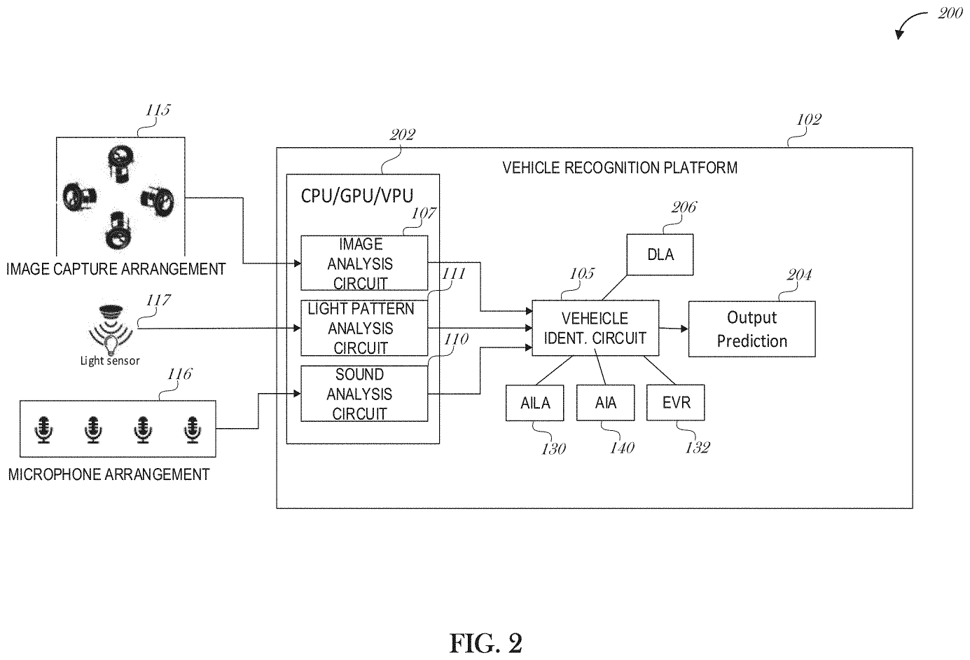

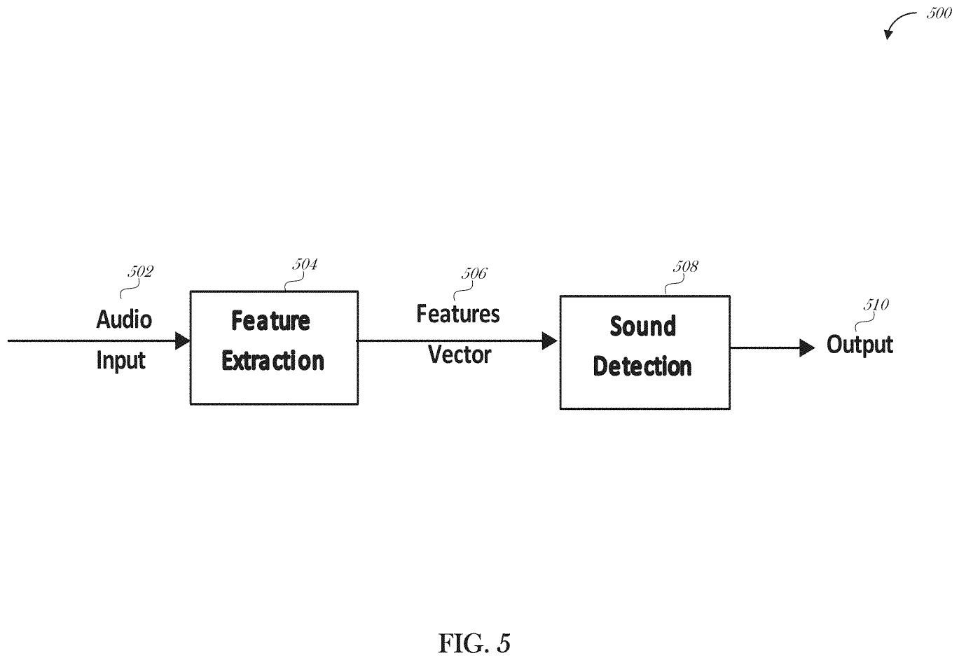

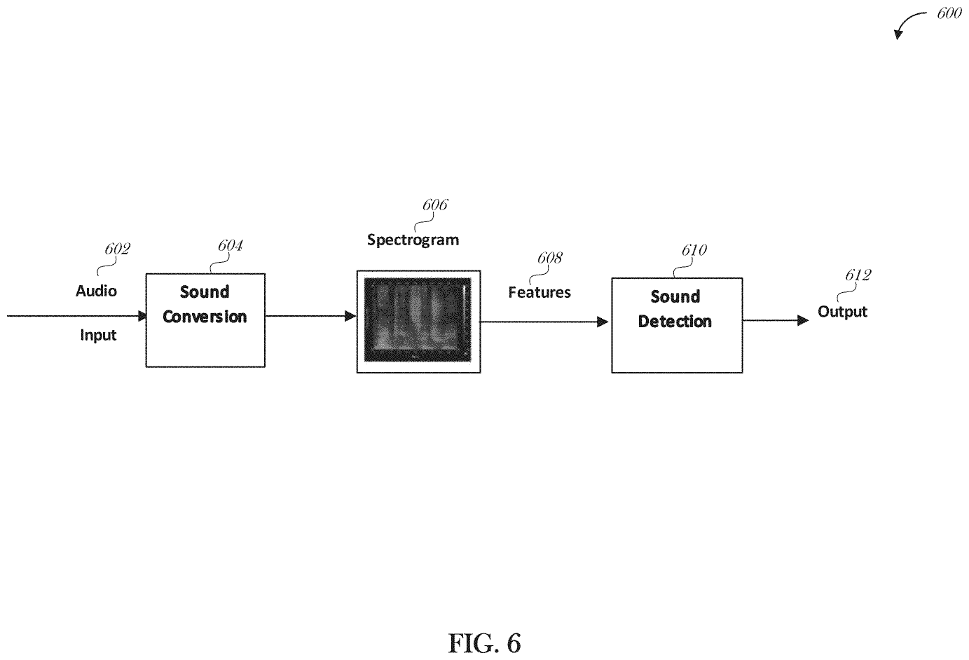

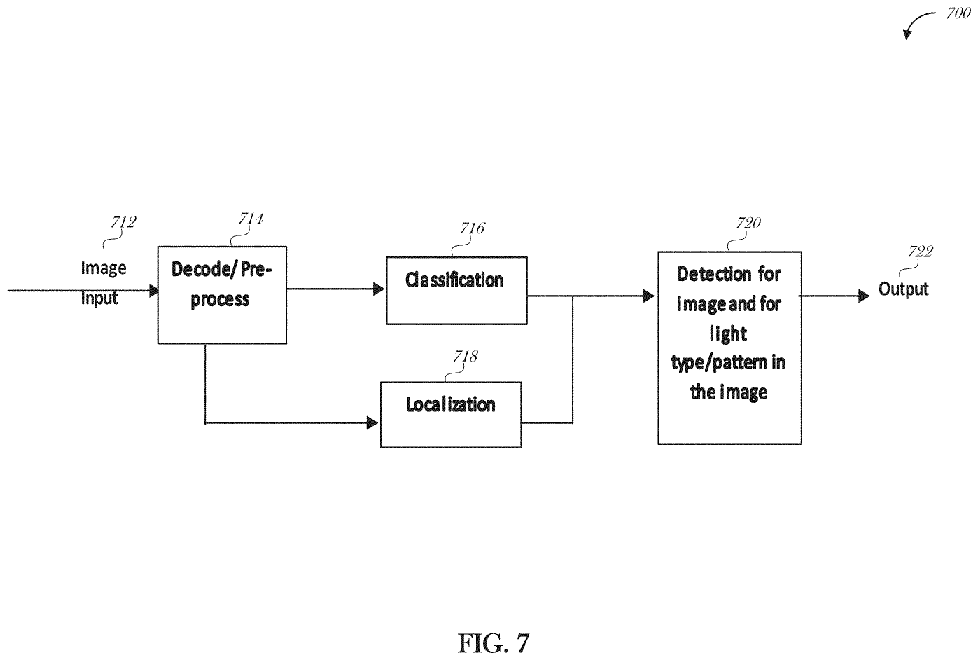

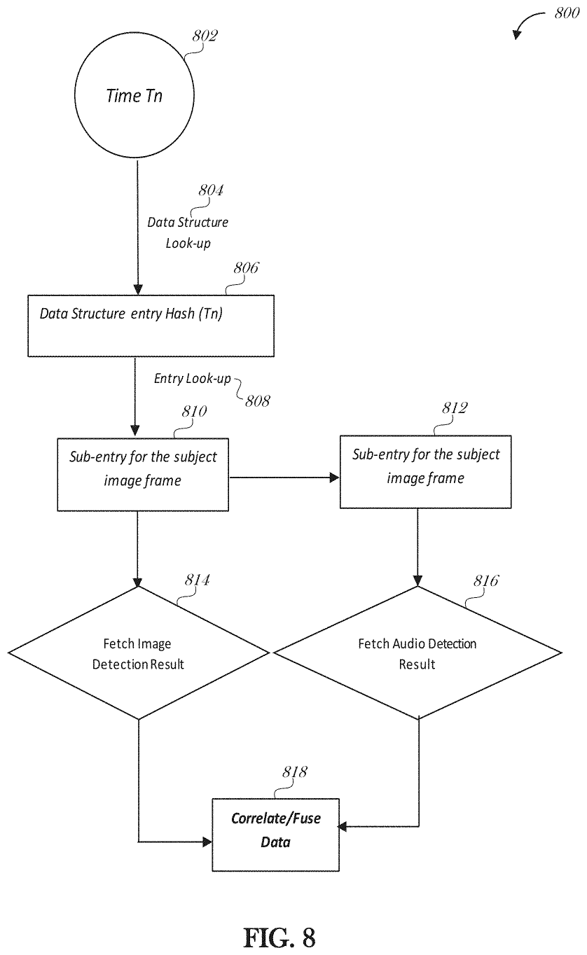

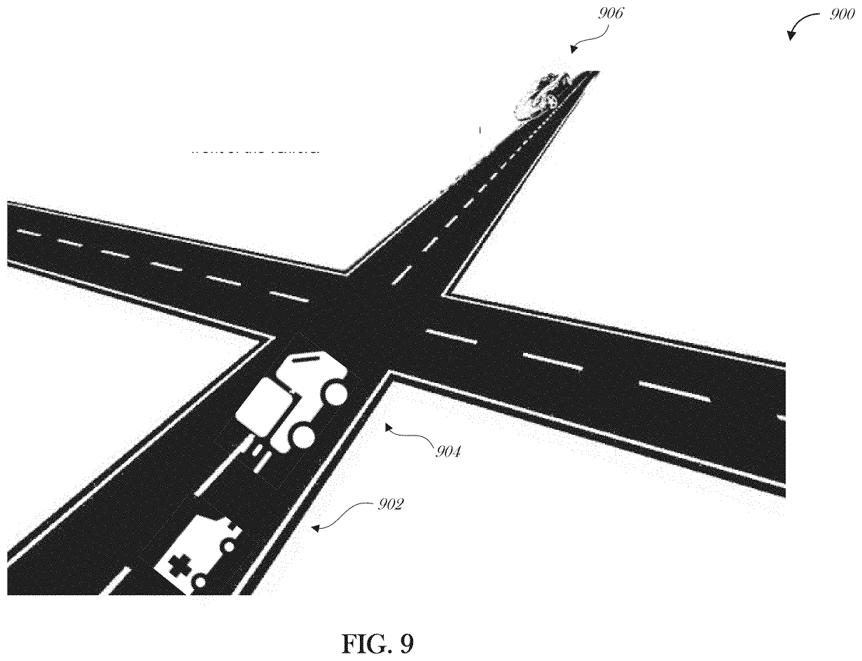

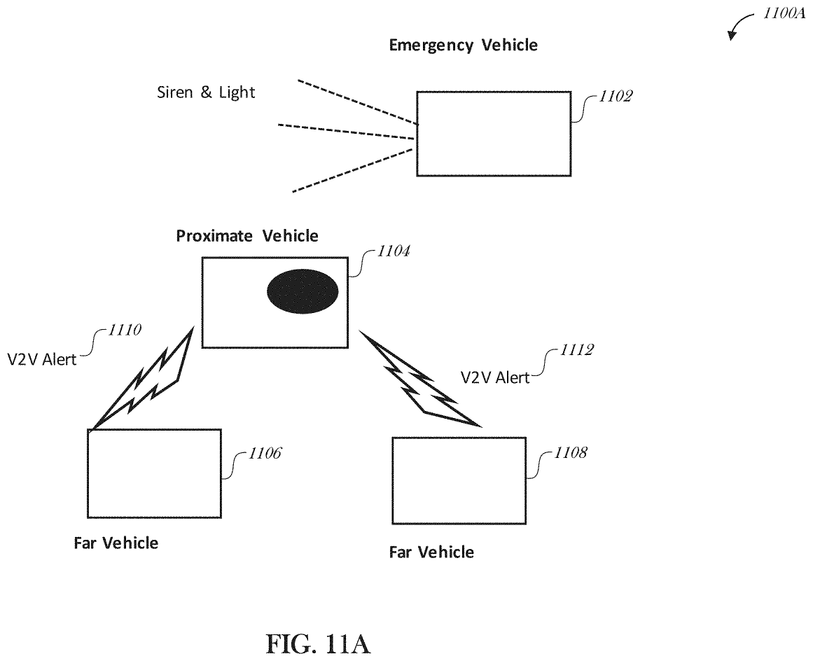

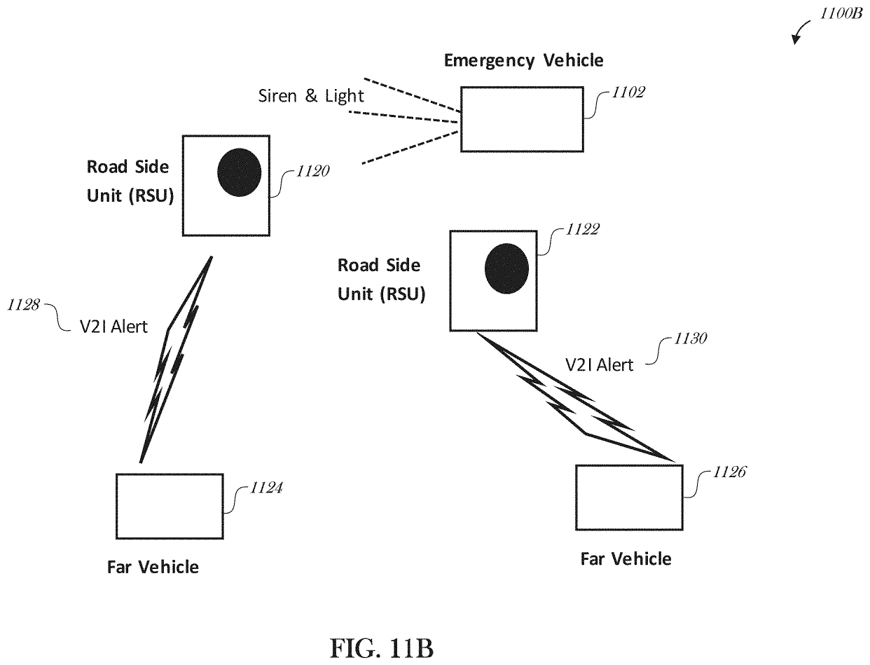

For instance, if the vehicle identification circuit 105 identifies a police siren based on the audio data and the image data, then the vehicle identification circuit 105 may transmit a message through the vehicle interface 112. The vehicle interface 112 may be directly or indirectly connected to an onboard vehicle infotainment system or other vehicle systems. In response to the message, the vehicle control system 118 or another component in the vehicle 104 may generate a notification to be presented to an occupant of the vehicle 104 on a display, with an audio cue, using haptic feedback in the seat or steering wheel, or the like. For example, when a police siren is detected by the vehicle identification circuit 105 using multimodal data (e.g., audio data, image data, outdoor light signals detected by corresponding sensors), an icon or other graphic representation may be presented on an in-dash display in the vehicle 104 to alert the occupant or operator of the vehicle 104 that an emergency vehicle is nearby. The message may also initiate other actions to cause the vehicle operator to provide attention to the detected situation, such as muting music playback, interrupting a phone call, or autonomously navigating vehicle 104 toward the side of the road and slowing the vehicle 104 to a stop. Other autonomous vehicle actions may be initiated depending on the type, severity, location, or other aspects of an event detected with the vehicle recognition platform 102. Various configurations of the vehicle recognition platform 102 are illustrated in FIG. 1B, FIG. 1C, and FIG. 2. Example processing functions performed by the sound analysis circuit 110 are discussed in connection with FIG. 5 in FIG. 6. Example processing functions performed by the image analysis circuit 107 are discussed in connection with FIG. 7. Additional functions related to emergency vehicle recognition are discussed in connection with FIG. 8, FIG. 9, and FIG. 11A-FIG. 13.

In an example embodiment, the functions discussed herein in connection with vehicle detection can be performed not only by a vehicle (e.g., vehicle 104) but other smart structures (or infrastructures). For example, such smart structures can perform vehicle detection and, e.g., upon detecting an emergency vehicle, control traffic lights, or perform other traffic control functions based on the detected vehicle.

FIG. 1B is a diagram 100B of separate detection pipelines processing sound data, light data, and image data in the vehicle recognition platform of FIG. 1A, according to an embodiment. Referring to FIG. 1B, the vehicle recognition platform 102 includes three separate detection pipelines processing sound data, light signals, and image data respectively. The sound data processing pipeline includes microphone arrangement 116, the sound processor 108 (not illustrated in FIG. 1B), and sound analysis circuit 110. The light data processing pipeline includes light sensor 117, light processor 113 (not illustrated in FIG. 1B), and light pattern analysis circuit 111. The image data processing pipeline includes image capture arrangement 115, the image processor 109 (not illustrated in FIG. 1B), and image analysis circuit 107.

In operation, the sound analysis circuit 110 analyzes audio data (e.g., using a machine learning technique such as a neural network as described in connection with FIG. 3 and FIG. 4) to determine a sound event, where the audio data is generated by a source outside the vehicle and is sensed by a microphone array (e.g., microphone arrangement 116) installed on the vehicle. The image analysis circuit 107 analyzes image data using the machine learning technique to determine an image event, where the image data is obtained by a camera array (e.g., image capture arrangement 115) installed on the vehicle. The light pattern analysis circuit 111 analyzes light signals received from the light sensor 117 using the machine learning technique to determine a light pattern event. In some aspects, the image event is detecting a visual representation of an emergency vehicle within at least one of a plurality of image frames within the image data. The sound event is detecting a sound associated with the emergency vehicle within at least one of a plurality of audio segments within the audio data. The light pattern event is detecting a light pattern associated with an emergency vehicle.

The detected events are communicated to the vehicle identification circuit 105 (not illustrated in FIG. 1B) which is configured to perform audio-image-light association (AILA) 130 and emergency vehicle recognition (EVR) 132 based on the detected events. In some aspects, the vehicle identification circuit 105 is configured to perform an audio-image association (AIA), such as AIA 140 in FIG. 1C, in place of AILA 130. In some aspects, the vehicle identification circuit 105 is configured to generate the AILA 130 by matching audio samples of the sound event with image frames of the image event and light signals of the light event for a plurality of time instances. The vehicle identification circuit 105 additionally generates EVR 132 based on the AILA 130 (e.g., by performing data correlation fusion as discussed in connection with FIG. 8, to determine a type of emergency vehicle that is recognized using the multimodal data from the three pipelines. In some aspects, at least two of the pipelines may be used by the vehicle identification circuit 105 to perform the emergency vehicle recognition 132 (e.g., as discussed in connection with FIG. 1C). In some aspects, the emergency vehicle recognition 132 may be further assisted by external alert signals 134, such as V2V or V2I alert signals (e.g., as illustrated in FIG. 11A and FIG. 11B).

FIG. 1C illustrates a diagram 100C of convolution neural network (CNN)-based detection pipelines processing sound data and image data in the vehicle recognition platform of FIG. 1A, according to an embodiment. Referring to FIG. 1C, the vehicle recognition platform 102 includes two separate detection pipelines processing sound data and image data respectively. The sound data processing pipeline includes microphone arrangement 116, sound processor 108, and sound analysis circuit 110 (not illustrated in FIG. 1C). The image data processing pipeline includes image capture arrangement 115, the image processor 109, and image analysis circuit 107 (not illustrated in FIG. 1C).

In operation, the sound analysis circuit 110 analyzes audio data (e.g., using a machine learning technique such as a neural network as described in connection with FIG. 3 and FIG. 4) to determine a sound event, where the audio data is generated by a source outside the vehicle and is sensed by a microphone array (e.g., microphone arrangement 116) installed on the vehicle. In some aspects, the sound analysis circuit 110 performs sound conversion 136 to image data, which image data can be used for detecting the sound event. In some aspects, the obtained image data from the sound conversion is also communicated to the image analysis circuit 107 for further processing and facilitating the detection of the image event.

The image analysis circuit 107 analyzes image data using the machine learning technique to determine an image event (e.g., by using CNN image detection 138), where the image data is obtained by a camera array (e.g., image capture arrangement 115) installed on the vehicle. In some aspects, the image event is detecting (or identifying) a visual representation of a vehicle (e.g., an emergency vehicle) within at least one of a plurality of image frames within the image data. The sound event is detecting (or identifying) a sound associated with the vehicle within at least one of a plurality of audio segments within the audio data.

The detected events are communicated to the vehicle identification circuit 105 (not illustrated in FIG. 1B) which is configured to perform audio-image association (AIA) 140 and emergency vehicle recognition (EVR) 134 based on the detected events. In some aspects, the vehicle identification circuit 105 is configured to generate the AIA 140 by matching audio samples of the sound event with image frames of the image event for a plurality of time instances. The vehicle identification circuit 105 additionally generates EVR 132 based on the AILA 130 (e.g., by performing data correlation fusion as discussed in connection with FIG. 8, to determine a type of emergency vehicle that is recognized using the multimodal data from the three pipelines. To generate the AIA 140, the vehicle identification circuit 105 is further to normalize a frame rate of the image frames with a sampling rate of the audio samples to determine audio samples per image frame (ASPIF) parameter for each time instance of the plurality of time instances. The ASPIF parameter is then used to generate a data structure representing the AIA 140 (an example data structure is illustrated hereinbelow).

FIG. 2 is a diagram 200 illustrating another view of the vehicle recognition platform 102 FIG. 1A, according to an embodiment. Referring to FIG. 2, the vehicle recognition platform 102 includes the image analysis circuit 107, the light pattern analysis circuit 111, and the sound analysis circuit 110, which can all be configured as a central processing unit (CPU) 202 (which can include a CPU, a graphics processing unit (GPU), a vision processing unit (VPU), or any AI processing unit). The CPU 202 communicates with image capture arrangement 115, light sensor 117, and the microphone arrangement 116 via the sensor array interface 106. Even though not illustrated in FIG. 2, the CPU 202 may further include the sound processor 108, the image processor 109, and the light processor 113. As illustrated in FIG. 2, the vehicle identification circuit 105 is configured to use a machine learning technique (e.g., a machine learning technique provided by a deep learning architecture (DLA) 206, as described in connection with FIG. 3 and FIG. 4) to generate AILA 130, AIA 140, and EVR 132 based on the multimodal inputs with the sound event, image event, and light event data from the CPU 202. The vehicle recognition platform 102 further uses the prediction generation circuit 103 to generate and output an emergency vehicle prediction 204. The prediction 204 may be transmitted (e.g., as a notification message or a command) to the vehicle control system 118 to notify a driver of the vehicle or perform an autonomous or a semiautonomous action associated with the vehicle based on prediction 204.

In some aspects, the image capture arrangement 115 includes four (or more) cameras used to construct a 3600 view (e.g., surround-view), which provides optimal coverage in detecting an emergency vehicle in all directions. In some aspects, the microphone arrangement 116 includes multiple microphones (e.g., four microphones) placed at different positions to “listen” to the siren of the emergency vehicle in all directions. The microphones may serve the following purposes: (a) recognize the emergency vehicle's siren by using sound classification algorithms, even when the emergency vehicle is further than a camera detection location or the line of sight of the emergency vehicle being blocked (e.g., as illustrated in FIG. 9); (b) predict the direction of arrival of the proximate emergency vehicle, either by sound intensity or time-different received by microphones; and (c) predict the speed of the approaching emergency vehicle by analyzing the Doppler shift of the siren.

FIG. 3 is a block diagram 300 illustrating the training of a deep learning (DL) model which can be used for vehicle recognition, according to some example embodiments. In some example embodiments, machine-learning programs (MLPs), including deep learning programs, also collectively referred to as machine-learning algorithms or tools, are utilized to perform operations associated with correlating data or other artificial intelligence (A)-based functions in connection with vehicle recognition (e.g., performing AI-based inferencing in vehicle 104 in connection with vehicle recognition).

As illustrated in FIG. 3, deep learning model training 308 is performed within the deep learning architecture (DLA) 306 based on training data 302 (which can include features). During the deep learning model training 308, features from the training data 302 can be assessed for purposes of further training of the DL model. The DL model training 308 results in a trained DL model 310. The trained DL model 310 can include one or more classifiers 312 that can be used to provide DL assessments 316 based on new data 314. In some aspects, the DLA 306 and the deep learning model training is performed in a network, remotely from vehicle 104. The trained model, however, can be included as part of the vehicle recognition platform 102 or the vehicle control system 118 or made available for access/use at a network location by the vehicle 104.

In some aspects, the training data 302 can include input data 303, such as image data, sound data, and light data supplied by image analysis circuit 307, the sound analysis circuit 310, and the light pattern analysis circuit 311 within the vehicle recognition platform 102. The input data 303 and the output data 305 (e.g., emergency vehicle information such as a type of emergency vehicle corresponding to the input data 303) are used during the DL model training 308 to train the DL model 310. In this regard, the trained DL model 310 receives new data 314 (e.g., multimodal data received by the vehicle identification circuit 105 from the sound analysis circuit 110, the image analysis circuit 107, and the light pattern analysis circuit 111), extracts features based on the data, and performs an event determination (e.g., determining a sound event based on audio data, determining an image event based on image data, and determining a light pattern event based on light signals) using the new data 314.

Deep learning is part of machine learning, a field of study that gives computers the ability to learn without being explicitly programmed. Machine learning explores the study and construction of algorithms, also referred to herein as tools, that may learn from existing data, may correlate data, and may make predictions about new data. Such machine learning tools operate by building a model from example training data (e.g., the training data 302) to make data-driven predictions or decisions expressed as outputs or assessments 316. Although example embodiments are presented with respect to a few machine-learning tools (e.g., a deep learning architecture), the principles presented herein may be applied to other machine learning tools.

In some example embodiments, different machine learning tools may be used. For example, Logistic Regression, Naive-Bayes, Random Forest, neural networks, matrix factorization, and Support Vector Machines tools may be used during the deep learning model training 308 (e.g., for correlating the training data 302).

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, the DLA 306 can be configured to use machine learning algorithms that utilize the training data 302 to find correlations among identified features that affect the outcome.

The machine learning algorithms utilize features from the training data 302 for analyzing the new data 314 to generate the assessments 316. The features include individual measurable properties of a phenomenon being observed and used for training the machine learning model. The concept of a feature is related to that of an explanatory variable used in statistical techniques such as linear regression. Choosing informative, discriminating, and independent features are important for the effective operation of the MLP in pattern recognition, classification, and regression. Features may be of different types, such as numeric features, strings, and graphs. In some aspects, training data can be of different types, with the features being numeric for use by a computing device.

In some aspects, the features used during the DL model training 308 can include the input data 303, the output data 305, as well as one or more of the following: sensor data from a plurality of sensors (e.g., audio, motion. GPS, image sensors); actuator event data from a plurality of actuators (e.g., wireless switches or other actuators); external information from a plurality of external sources; timer data associated with the sensor state data (e.g., time sensor data is obtained), the actuator event data, or the external information source data; user communications information; user data; user behavior data, and so forth.

The machine learning algorithms utilize the training data 302 to find correlations among the identified features that affect the outcome of assessments 316. In some example embodiments, the training data 302 includes image data, light data, and audio data from a known emergency vehicle (which information is used as the output training data 305). With the training data 302 (which can include identified features), the DL model is trained using the DL model training 308 within the DLA 306. The result of the training is the trained DL model 310 (e.g., the neural network 420 of FIG. 4). When the DL model 310 is used to perform an assessment, new data 314 is provided as an input to the trained DL model 310, and the DL model 310 generates the assessments 316 as an output. For example, the DLA 306 can be deployed at a computing device within a vehicle (e.g., as part of the vehicle recognition platform 102) and the new data 314 can include image, sound, and light data received via the sensor array interface 106.

FIG. 4 illustrates the structure of a neural network which can be used for vehicle recognition, according to an example embodiment. The neural network 420 takes source domain data 410 (e.g., audio data, image data, and light signals obtained by the sensor array interface 106 within the vehicle recognition platform 102) as input, processes the source domain data 410 using the input layer 430; the intermediate, hidden layers 440A, 440B, 440C, 440D, and 440E; and the output layer 450 to generate a result 460. In some aspects, result 460 includes a sound event, an image event, a light pattern event used for emergency vehicle recognition.

Each of the layers 430-450 comprises one or more nodes (or “neurons”). The nodes of the neural network 420 are shown as circles or ovals in FIG. 4. Each node takes one or more input values, processes the input values using zero or more internal variables, and generates one or more output values. The inputs to the input layer 430 are values from the source domain data 410. The output of the output layer 450 is the result 460. The intermediate layers 440A-440E are referred to as “hidden” because they do not interact directly with either the input or the output, and are completely internal to the neural network 420. Though five hidden layers are shown in FIG. 4, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the model is evaluated and the values of its variables are adjusted to attempt to better refine the model iteratively. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to the desired result, but as the training dataset may be varied, and is preferably very large, perfect accuracy and precision may not be achievable. A number of epochs that make up a learning phase, therefore, may be set as a given number of trials or a fixed time/computing budget or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine the accuracy of the model in handling data that it has not been trained on. In a second example, a false positive rate or false-negative rate may be used to evaluate the models after finalization. In a third example, a delineation between data clusterings is used to select a model that produces the clearest bounds for its clusters of data.

The neural network 420 may be a deep learning neural network, a deep convolutional neural network, a recurrent neural network, or another type of neural network. A neuron is an architectural element used in data processing and artificial intelligence, particularly machine learning, that includes a memory that may determine when to “remember” and when to “forget” values held in that memory based on the weights of inputs provided to the given neuron. An example type of neuron in the neural network 420 is a Long Short Term Memory (LSTM) node. Each of the neurons used herein is configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance is related to one another.

For example, an LSTM serving as a neuron includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

A neural network sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons, can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to w % bat extent that signal progresses further through the network to affect the outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In the training of a DNN architecture, a regression, which is structured as a set of statistical processes for estimating the relationships among variables, can include minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing the desired task. For a given neural network, there may be millions of parameters to be optimized. Trying to optimize all these parameters from scratch may take hours, days, or even weeks, depending on the number of computing resources available and the amount of data in the training set.

FIG. 5 illustrates an audio data processing pipeline 500 which can be used in a vehicle recognition platform, according to an embodiment. Referring to FIG. 5, audio input 502 is received via the microphone arrangement 116 and is initially processed by the sound processor 108 before processing by the sound analysis circuit 110. More specifically, the sound analysis circuit 110 performs feature extraction 504 that results in a feature vector 506 for each audio frame of a plurality of audio segments associated with the audio input 502. The sound analysis circuit 110 further uses a machine learning technique (e.g., a neural network or another type of machine learning technique such as described in connection with FIG. 3 and FIG. 4) to perform sound detection 508 based on the feature vector 506 for each audio sample. In an example embodiment, sound detection 508 uses machine learning frameworks (e.g., support vector processing, random forest processing, etc.) to generate output 510. In some aspects, output 510 includes a determination of a sound event including detecting one or more sounds associated with an emergency vehicle within one or more of the audio segments associated with audio input 502.

FIG. 6 illustrates an audio data processing pipeline 600 with the signal-to-image conversion which can be used in a vehicle recognition platform, according to an embodiment. Referring to FIG. 6, audio input 602 is received via the microphone arrangement 116 and is initially processed by the sound processor 108 before processing by the sound analysis circuit 110. In some aspects, the sound analysis circuit 110 performs audio features extraction and detection leveraging a CNN used in image analytics. More specifically, sound conversion 604 is performed on the audio data 602 to generate a corresponding spectrogram 606. Features 608 of the spectrogram 606 are used as input to the CNN to perform sound detection 610 based on the features 610 to generate output 612. In some aspects, output 612 includes a determination of a sound event including detecting one or more sounds associated with an emergency vehicle within one or more of the audio segments associated with audio input 602.

FIG. 7 illustrates an image data processing pipeline 700 which can be used in a vehicle recognition platform, according to an embodiment. Referring to FIG. 7, image data 712 is received as input via the image capture arrangement 115 and is initially processed by the image processor 109 before processing by the image analysis circuit 107. More specifically, the image analysis circuit 107 performs initial decoding and pre-processing 714. The image analysis circuit 107 further uses a machine learning technique (e.g., a neural network or another type of machine learning technique such as described in connection with FIG. 3 and FIG. 4) to perform object classification 716 and object localization 718 using the image data. The image analysis circuit 107 further uses the machine learning technique to perform image detection 720 which can include detecting an image event (e.g., a visual representation of an emergency vehicle detected within at least one image frame of the image data) as well as detection of light type or light pattern within the image that are characteristic of an emergency vehicle. The detected image event and light pattern are used to generate output 722.

In some aspects, emergency vehicle light detection and recognition can take place through signal processing, where light detectors match the received light signals to existing templates (e.g., using the data processing pipelines illustrated in FIG. 1B). In other aspects, emergency vehicle light detection and recognition can take place through image processing, where light spots in the image are detected then classification takes place through a neural network (e.g., using the data processing pipelines illustrated in FIG. 1C).

Audio-Image Association

Following the audio, light, and image event detection, an association between the emergency vehicle image, and the emergency vehicle sound takes place to accurately recognize the emergency vehicle type based on the audio, light, and image data. In some aspects, generating the audio-image association may include the following:

(a) Audio-image normalization and association. As the audio signals sampling rate is larger than the images frames-per-second (fps) rate, normalization is applied to allow for associating the detected image with the detected audio every second.

(b) Normalization and association may consider audio sampling normalization over time to match the image frames rate, audio samples association with each image frame, and sound event associated with each image frame. Table 1 below describes audio-image normalization and association parameters that can be used in connection with emergency vehicle recognition.

TABLE 1

| Normalization/Association | Description |
|---|---|
| Audio sampling over time | Audio Samples Per Second (ASPS) = |
| | Audio sampling rate/ims |
| | Example: for 16 KHz audio, audio |
| | samples per second = 16,000 |
| Audio samples association | Audio Samples Per Image Frame |
| with each Image Frame | (ASPIF) = ASPS/Image FPS |
| | Example: for 30 fps images rate, |
| | ASPS = 16000, and ASPIF = |
| | 16000/30 = 533 |
| Sound event associated | Sound event Per Image Frame (SEPIF) = |
| to each image frame | Clustering {SED₁, . . . , SEDₙ}, |
| | where SED is the sound event |
| | detected, and n = number of ASPIF |
| | For example: if we have 1600 ASPIF |
| | for each image frame, the SEPIF is the |
| | result of a clustering algorithm, such as |
| | K-Means, across SED through all |
| | ASPIF |

In some aspects, the vehicle identification circuit 105 within the vehicle recognition platform 102 generates an audio-image association as a data structure (e.g., a table) for analytics insights that is created and continuously updated with time. In some aspects, the audio-image association is generated based on matching audio samples of the sound event with image frames of the image event for a plurality of time instances.

Table 2 illustrates an example audio-image association data structure, which shows over time the detection result for each image frame and each group of audio samples associated with each image frame. Entries lifetime in this data structure can be set to 1 or 2 hours (i.e., stale entries are removed to save size).

TABLE 2

| | | | | Audio |
|---|---|---|---|---|
| Hash | | Image Frame | | Sample |
| (time | Image | Detection | | Detection |
| in sec) | Frame ID | Results | Audio Sample ID | Results |
| Hash | frameᵢ | frameᵢ | sampleᵢ | frameᵢ |
| (T₀) | | Detected | sampleᵢ₊₁ | Detected |
| | | Object | . . . | Sound |
| | | | sampleₙ (n = ASPIF) | |
| | frameᵢ₊₁ | frameᵢ₊₁ | sampleᵢ | |
| | | Detected | sampleᵢ₊₁ | |
| | | Object | . . . | |
| | | | sampleₙ (n = ASPIF) | |
| | . . . | . . . | . . . | . . . |
| | frameₙ | frameₙ | sampleᵢ | |
| | (n = fps) | Detected | sampleᵢ₊₁ | |
| | | Object | . . . | |
| | | | sampleₙ (n = ASPIF) | |
| Hash | | | | |
| (T₁) | | | | |
| . . . | . . . | . . . | . . . | . . . |
| Hash | | | | |
| (Tₙ) | | | | |

In some aspects, to generate the audio-image association (e.g., as illustrated in Table 2), the vehicle identification circuit 105 normalizes a frame rate of the image frames with a sampling rate of the audio samples to determine audio samples per image frame (ASPIF) parameter for each time instance of the plurality of time instances (e.g., as illustrated in Table 1). In some aspects, the audio-image association is a data structure, and the vehicle identification circuit 105 stores the following information in the data structure (for each image frame of the image frames): an identifier of a time instance of the plurality of time instances corresponding to the image frame; an identifier of the image frame; identifiers of a subset of the audio samples corresponding to the image frame based on the ASPIF parameter; a detection result associated with the image frame, the detection result based on the image event; and a detection result associated with each audio sample of the subset of audio samples, the detection result based on the sound event.

In some aspects, the detection result associated with the image frame (e.g., Frameᵢ Detected Object) is a type of emergency vehicle detected within the image frame. In some aspects, the detection result (e.g., as indicated in column “Audio Sample Detection Result” in Table 2) associated with each audio sample of the subset of audio samples (e.g., Sampleᵢ-Sampleₙ) is a type of emergency vehicle detected based on the audio sample.

In some aspects, the vehicle identification circuit 105 is further to apply a clustering function to the detection results associated with the subset of audio samples to generate a combined detection result associated with the subset of audio samples. More specifically, the vehicle identification circuit 105 applies a clustering function to the detection result indicated for each audio sample in column “Audio Sample Detection Results” for a given image frame. After the combined detection result for the subset of audio samples is generated, the vehicle identification circuit 105 performs data fusion of the detection result associated with the image frame and the combined detection result associated with the subset of audio samples to perform the emergency vehicle recognition.

FIG. 8 is a flowchart illustrating method 800 for audiovisual detection correlation and fusion for vehicle recognition, according to an embodiment. Referring to Table 2 and FIG. 8, method 800 can be performed for a specific time instance, such as time Tn selected at operation 802. At operation 804, a data structure lookup is performed (e.g., by referencing the audio-image association represented by the data structure, such as illustrated in Table 2). At operation 806, the entry for hash value Tn is located, and data in the entry is obtained at operation 808. At operations 810 and 812, subentries for the subject image frame are obtained including determining audio sample IDs for a subset of audio samples corresponding to the frame at time instance Tn. At operation 814, the image frame detection result is obtained (e.g., the detection result may include a detected image event). At operation 816, the audio sample detection results are obtained and a combined detection result for all audio samples associated with time instance Tn is determined (e.g., a detected sound event determined after a clustering function is applied to detection results for all audio samples associated with time instance Tn). At operation 818, a data correlation or fusion is performed between the combined detection result for all audio samples and the image frame detection result to determine a final detection result.

Light-Image Association

In some aspects, if light detection takes place through light spot detection in obtained image data and a machine learning technique (e.g., a neural network) is applied (e.g., as illustrated in FIG. 1C), light and image rates can follow the image fps rate. In this case, the audio sampling rate is normalized to the image fps. If light detection takes place through a separate pipeline (e.g., as illustrated in FIG. 1B), a normalization process may be used to normalize the light-emitting frequency with the audio sampling frequency and the image data fps rate.

In some aspects, to avoid any disturbance with the human eye and to convey the sense of urgency, a warning signal design for generating an emergency vehicle recognition notification considers operation at flash rates in the frequency range of 1-3 Hz (i.e., 60-180 fpm “flash per minute”). The same approach of audio sampling normalization and association to image data (shown in Table 1 and Table 2) applies to light sampling normalization and association to image and audio data.

Audio/Sound Source Localization (SSL) Module

In some aspects, the vehicle recognition platform 102 includes sound source localization performed by an SSL module (not illustrated in the figures) as an additional feature. The goal of having the SSL module is to automatically estimate the position of emergency sound sources. There are two components of a source position that can be estimated as part of the SSL module: direction-of-arrival estimation and distance estimation.

In some aspects, the SSL module may use 1D-, 2D- and 3D-dimensional localization techniques based on Time-Delay-Of-Arrival (TDOA) and Direction-Of-Arrival (DOA) algorithms implemented with an array of microphones. In some aspects, the localization module is configured to calculate the relative speed of the emergency vehicle by using data from the localization (TDOA/DOA) at regular intervals augmented by analysis of doppler shift in the sound emitted by the emergency vehicle. Table 3 shows an example of AV incorporating the directional prediction functionality.

TABLE 3

| | Emergency Vehicle | |
|---|---|---|
| | direction with respective | |
| Scenario | to AV | AV reaction |
| 1 | Coming from behind | Pull aside |
| 2 | Coming from front | Give way at junction |
| 3 | Coming from left or right | Give way at junction |

FIG. 9 illustrates diagram 900 of example locations of vehicles during emergency vehicle recognition using the disclosed techniques, according to an embodiment. Referring to FIG. 9, vehicle 906 may use the disclosed emergency vehicle recognition techniques. A larger vehicle (e.g., a truck) 904 is driving in front of an emergency vehicle 902 and is blocking the view of vehicle 906 to the emergency vehicle 902. However, vehicle 906 uses a vehicle recognition platform (e.g., platform 102) and detects the forward-coming emergency vehicle 902 via sound, light, and image classification using sensor data from sensors installed on vehicle 906.

FIG. 10 is a flowchart illustrating a method 1000 for transfer learning used in connection with continuous learning by a neural network model used for vehicle recognition, according to an embodiment. The method 1000 may be performed as part of the neural network processing 119 by the vehicle control system 118, the vehicle identification circuit 105, or any other circuit within the vehicle recognition platform 102. Alternatively, the neural network model training may be performed remotely (outside of the vehicle 104) and the vehicle may be configured with the trained neural network model (or provided access to the trained model which can be stored in remote network storage).

In some aspects, method 1000 may use a preloaded database of the sirens and emergency vehicles as training data. Additionally, the vehicle recognition platform 102 may use a continuous learning module (e.g., as part of the vehicle identification circuit 105 or the neural network processing module 119) to help monitor the accuracy of the training data. More specifically, the continuous learning module allows the image capture arrangement 115 to verify the detection and feedback to the system for any correction, as illustrated in FIG. 10 and described hereinbelow.

At operation 1002, the neural network processing module 119 determines whether a siren is detected. If a siren is detected, at operation 1004, audio classification is performed and a sound event is determined. At operation 1006, a predetermined delay is introduced (e.g., 30 seconds). At operation 1008, image data is analyzed to determine the presence of an image event. At operation 1010, emergency vehicle recognition is performed to determine a specific type of emergency vehicle based on the presence of the image event and the sound event. If the specific type of emergency vehicle (e.g., an ambulance) is correctly recognized, at operation 1012 weights are updated and the training process ends. If the specific type of emergency vehicle is not correctly recognized, then a new processing delay is introduced at operation 1014. At operation 1016, a determination is made whether a total training time has passed (e.g., two minutes). If the total training time has not passed, training resumes at operation 1008. If the total training time has passed, processing resumes at operation 1018 where a training failed determination is made and the neural network weights are updated accordingly at operation 1020. Operations 1016-1020 relate to inferencing using a neural network model for vehicle detection. If inference continuation failed, the new dataset will be fed back to a backend server (or a cloud server) for retraining the model. The new pre-trained model will then be loaded back to the vehicle.

Even though emergency vehicle recognition techniques are described herein as being performed by a vehicle recognition platform within a vehicle, the disclosure is not limited in this regard. More specifically, the disclosed techniques may be performed by a recognition platform implemented in other types of devices such as RSUs, base stations, etc.

FIG. 11A and FIG. 11B illustrate V2V and V2I cooperation for emergency vehicle notifications, according to an embodiment. FIG. 1A illustrates diagram 1100A of V2V cooperation. A vehicle 1104 proximate to the emergency vehicle 1102 can recognize the emergency vehicle using the disclosed emergency vehicle recognition techniques (e.g., using multi-modal detection based on sensed audio, image, and light data). The vehicle 1104 may share with vehicles 1106 and 1108 in its vicinity, through V2V messages 1110 and 1112, information on the presence of the emergency vehicle 1102 and its location and speed.

FIG. 11B illustrates a diagram 1100B of V2I cooperation. A Road Side Units (RSUs) 1120 and 1122 proximate to the emergency vehicle 1102, can recognize the emergency vehicle 1102 using the disclosed emergency vehicle recognition techniques (e.g., using multi-modal detection based on sensed audio, image, and light data). The RSUs 1120 and 1122 may share with vehicles in their vicinity (e.g., vehicles 1124 and 1126), through V2I messages (e.g., messages 1128 and 1130), information on the presence of the emergency vehicle 1102 as well as its location and speed.

In some aspects, the cooperative detection provides extended sensing capabilities and adds to the multi-modal recognition of emergency vehicles. It also helps road circulation, where vehicles in bigger coverage of emergency vehicles can clear the way in a cooperative manner.

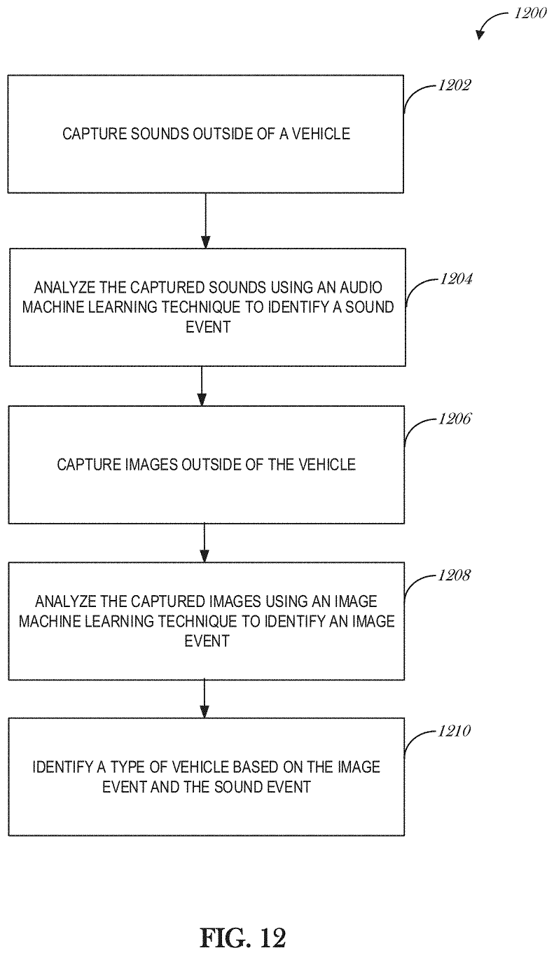

FIG. 12 is a flowchart illustrating method 1200 for emergency vehicle recognition, according to an embodiment. Method 1200 includes operations 1202, 1204, 1206, 1208, and 1210, which can be performed by, e.g., one or more circuits within the vehicle recognition platform 102. AT operation 1202, sounds outside of a vehicle are captured (e.g., via the microphone arrangement 116). At operation 1204, the captured sounds are analyzed using an audio machine learning technique to identify a sound event. For example, the sound analysis circuit 110 analyzes audio data received from the microphone arrangement 116 to identify a sound evet. At operation 1206, images outside of the vehicle are captured (e.g., using the image capture arrangement 115). At operation 1208, the captured images are analyzed using an image machine learning technique to identify an image event. At operation 1210, a type of vehicle is identified based on the image event and the sound event.

In some aspects, an audio-image association is generated (e.g., by the vehicle identification circuit 105). The audio-image association matches audio samples of the sound event with image frames of the image event for a plurality of time instances. Vehicle recognition is performed to identify the type of vehicle based on the audio-image association. A message is communicated to a vehicle control system via a vehicle interface, where the message is based on vehicle recognition.

In some aspects, the image event is detecting a visual representation of a vehicle within at least one of the image frames, and the sound event is detecting a sound associated with the vehicle within at least one of the audio samples. Generating the audio-image association includes normalizing a frame rate of the image frames with a sampling rate of the audio samples to determine an audio samples per image frame (ASPIF) parameter for each time instance of the plurality of time instances.

In some aspects, the audio-image association is a data structure and the method further includes, for each image frame of the image frames, the following information may be stored in the data structure: an identifier of a time instance of the plurality of time instances corresponding to the image frame; an identifier of the image frame; identifiers of a subset of the audio samples corresponding to the image frame based on the ASPIF parameter; a detection result associated with the image frame, the detection result based on the image event; and a detection result associated with each audio sample of the subset of audio samples, the detection result based on the sound event.

In some aspects, the detection result associated with the image frame is a type of vehicle detected within the image frame. The detection result associated with each audio sample of the subset of audio samples is a type of vehicle detected based on the audio sample. In some aspects, a clustering function is applied to the detection results associated with the subset of audio samples to generate a combined detection result associated with the subset of audio samples. In some aspects, performing vehicle recognition includes performing data fusion of the detection result associated with the image frame and the combined detection result associated with the subset of audio samples. In some aspects, the message is generated for transmission to the vehicle control system, where the message includes the type of vehicle. The type of vehicle is a type of emergency vehicle. The vehicle control system performs a responsive action based on the message indicating the type of emergency vehicle.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include machine-readable media including read-only memory (ROM), random-access memory (RAM), magnetic disk storage media, optical storage media, flash-memory devices, and other storage devices and media.

A processor subsystem may be used to execute the instruction on the machine-readable media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field-programmable gate array (FPGA), or a fixed-function processor.

Examples, as described herein, may include, or may operate on, logic or a number of components, modules, or mechanisms. Modules may be hardware, software, or firmware communicatively coupled to one or more processors to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. The software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system-on-chip (SoC), desktop computers, laptop computers, tablet computers, servers, smartphones, etc.

As used in any embodiment herein, the term “logic” may refer to firmware and/or circuitry configured to perform any of the aforementioned operations. Firmware may be embodied as code, instructions, or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic, and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

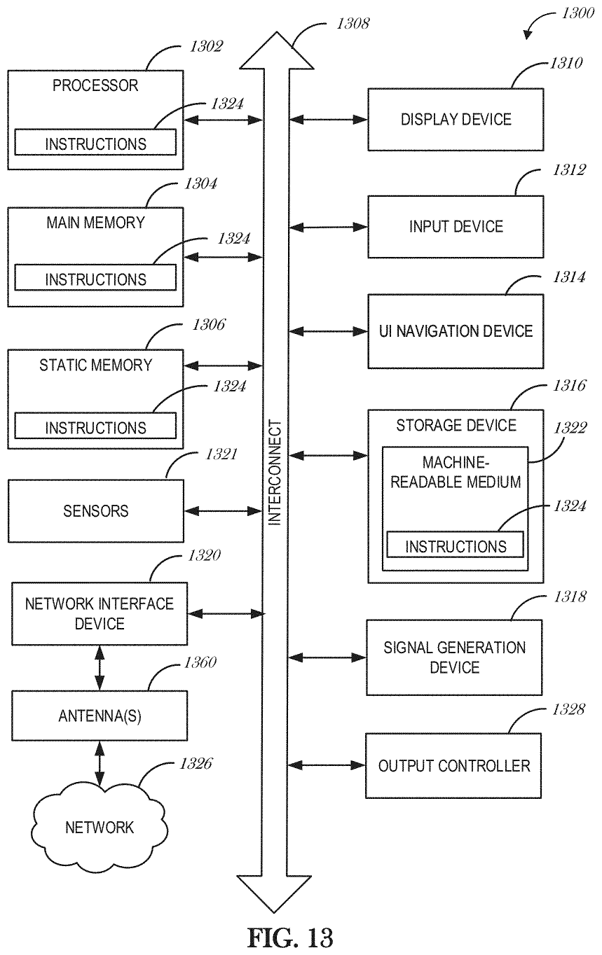

FIG. 13 is a block diagram illustrating a machine in the example form of a computer system 1300, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The example computer system 1300 includes at least one processor 1302 (e.g., a central processing unit (CPU), a graphics processing unit (GPU) or both, processor cores, compute nodes, etc.), a main memory 1304, and a static memory 1306, which communicate with each other via a link 1308 (e.g., bus). The computer system 1300 may further include a video display unit 1310, an alphanumeric input device 1312 (e.g., a keyboard), and a user interface (UI) navigation device 1314 (e.g., a mouse). In one embodiment, the video display unit 1310, input device 1312, and UI navigation device 1314 are incorporated into a touch screen display. The computer system 1300 may additionally include a storage device 1316 (e.g., a drive unit), a signal generation device 1318 (e.g., a speaker), a network interface device 1320, and one or more sensors (not shown), such as a global positioning system (GPS) sensor, compass, accelerometer, gyrometer, magnetometer, or other sensors. In some aspects, processor 1302 can include a main processor and a deep learning processor (e.g., used for performing deep learning functions including the neural network processing discussed hereinabove).

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system 1300, with the main memory 1304, static memory 1306, and the processor 1302 also constituting machine-readable media.

While the machine-readable medium 1322 is illustrated in an example embodiment to be a single medium, the term “machine-readable medium” may include a single medium or multiple media (e.g., a centralized or distributed database, and/or associated caches and servers) that store the one or more instructions 1324. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include nonvolatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible media to facilitate communication of such software.

### Additional Notes & Examples

Example 1 is a vehicle recognition system comprising: a microphone arrangement operatively mounted in a vehicle to capture sounds outside of the vehicle; a sound analysis circuit to analyze the captured sounds using an audio machine learning technique to identify a sound event; an image capture arrangement operatively mounted in the vehicle to capture images outside of the vehicle; an image analysis circuit to analyze the captured images using an image machine learning technique to identify an image event, and a vehicle identification circuit to identify a type of vehicle based on the image event and the sound event.

In Example 2, the subject matter of Example 1 includes, wherein the vehicle identification circuit is configured to generate an audio-image association, the audio-image association matching audio samples of the sound event with image frames of the image event for a plurality of time instances; perform a vehicle recognition to identify the type of vehicle based on the audio-image association; and transmit a message to a vehicle control system via a vehicle interface, the message based on the vehicle recognition.

In Example 3, the subject matter of Example 2 includes, wherein the image event is detecting a visual representation of a vehicle within at least one of the image frames, and wherein the sound event is detecting a sound associated with the vehicle within at least one of the audio samples.

In Example 4, the subject matter of Examples 2-3 includes, wherein to generate the audio-image association, the vehicle identification circuit is further configured to normalize a frame rate of the image frames with a sampling rate of the audio samples to determine an audio samples per image frame (ASPIF) parameter for each time instance of the plurality of time instances.

In Example 5, the subject matter of Example 4 includes, wherein the audio-image association is a data structure and the vehicle identification circuit is further configured to for each image frame of the image frames, store in the data structure: an identifier of a time instance of the plurality of time instances corresponding to the image frame; an identifier of the image frame; identifiers of a subset of the audio samples corresponding to the image frame based on the ASPIF parameter; a detection result associated with the image frame, the detection result based on the image event; and a detection result associated with each audio sample of the subset of audio samples, the detection result based on the sound event.

In Example 6, the subject matter of Example 5 includes, wherein the detection result associated with the image frame is a type of vehicle detected within the image frame.

In Example 7, the subject matter of Example 6 includes, wherein the detection result associated with each audio sample of the subset of audio samples is a type of vehicle detected based on the audio sample.

In Example 8, the subject matter of Example 7 includes, wherein the vehicle identification circuit is further configured to apply a clustering function to the detection results associated with the subset of audio samples to generate a combined detection result associated with the subset of audio samples; and perform data fusion of the detection result associated with the image frame and the combined detection result associated with the subset of audio samples to perform the vehicle recognition.

In Example 9, the subject matter of Examples 2-8 includes, wherein the vehicle identification circuit is further configured to generate the message for transmission to the vehicle control system, the message including the type of vehicle.

In Example 10, the subject matter of Example 9 includes, wherein the type of vehicle is a type of emergency vehicle, and wherein the vehicle control system performs a responsive action based on the message indicating the type of emergency vehicle.

In Example 11, the subject matter of Example 10 includes, wherein the responsive action comprises an autonomous vehicle maneuver based on the type of emergency vehicle detected during vehicle recognition.

In Example 12, the subject matter of Examples 1-11 includes, wherein the audio machine learning technique and the image machine learning technique comprise an artificial neural network, and wherein identifying the type of vehicle is further based on identifying a light event based on light signals captured outside of the vehicle.

Example 13 is a method for vehicle recognition, the method comprising: capturing sounds outside of a vehicle; analyzing, by one or more processors of the vehicle, the captured sounds using an audio machine learning technique to identify a sound event; capturing images outside of the vehicle; analyzing, by the one or more processors, the captured images using an image machine learning technique to identify an image event; and identifying, by the one or more processors, a type of vehicle based on the image event and the sound event.

In Example 14, the subject matter of Example 13 includes, generating, by the one or more processors, an audio-image association, the audio-image association matching audio samples of the sound event with image frames of the image event for a plurality of time instances; performing, by the one or more processors, a vehicle recognition to identify the type of vehicle based on the audio-image association; and transmitting, by the one or more processors, a message to a vehicle control system via a vehicle interface, the message based on the vehicle recognition.

In Example 15, the subject matter of Example 14 includes, wherein the image event is detecting a visual representation of a vehicle within at least one of the image frames, and wherein the sound event is detecting a sound associated with the vehicle within at least one of the audio samples.

In Example 16, the subject matter of Examples 14-15 includes, wherein generating the audio-image association comprises: normalizing, by the one or more processors, a frame rate of the image frames with a sampling rate of the audio samples to determine an audio samples per image frame (ASPIF) parameter for each time instance of the plurality of time instances.

In Example 17, the subject matter of Example 16 includes, wherein the audio-image association is a data structure and the method further comprises for each image frame of the image frames, storing, by the one or more processors, in the data structure: an identifier of a time instance of the plurality of time instances corresponding to the image frame; an identifier of the image frame; identifiers of a subset of the audio samples corresponding to the image frame based on the ASPIF parameter; a detection result associated with the image frame, the detection result based on the image event; and a detection result associated with each audio sample of the subset of audio samples, the detection result based on the sound event.

In Example 18, the subject matter of Example 17 includes, wherein the detection result associated with the image frame is a type of vehicle detected within the image frame.

In Example 19, the subject matter of Example 18 includes, wherein the detection result associated with each audio sample of the subset of audio samples is a type of vehicle detected based on the audio sample.

In Example 20, the subject matter of Example 19 includes, applying, by the one or more processors, a clustering function to the detection results associated with the subset of audio samples to generate a combined detection result associated with the subset of audio samples; and performing, by the one or more processors, data fusion of the detection result associated with the image frame and the combined detection result associated with the subset of audio samples to perform the vehicle recognition.

In Example 21, the subject matter of Examples 14-20 includes, generating, by the one or more processors, the message for transmission to the vehicle control system, the message including the type of vehicle, wherein the type of vehicle is a type of emergency vehicle, and wherein the vehicle control system performs a responsive action based on the message indicating the type of emergency vehicle.

Example 22 is at least one non-transitory machine-readable medium including instructions for vehicle recognition in a vehicle, the instructions when executed by a machine, cause the machine to perform operations comprising: capturing sounds outside of a vehicle; analyzing the captured sounds using an audio machine learning technique to identify a sound event; capturing images outside of the vehicle; analyzing the captured images using an image machine learning technique to identify an image event, and identifying a type of vehicle based on the image event and the sound event.

In Example 23, the subject matter of Example 22 includes, wherein the instructions further cause the machine to perform operations comprising: generating an audio-image association, the audio-image association matching audio samples of the sound event with image frames of the image event for a plurality of time instances; performing a vehicle recognition to identify the type of vehicle based on the audio-image association; transmitting a message to a vehicle control system via a vehicle interface, the message based on the vehicle recognition; and normalizing a frame rate of the image frames with a sampling rate of the audio samples to determine an audio samples per image frame (ASPIF) parameter for each time instance of the plurality of time instances.

In Example 24, the subject matter of Example 23 includes, wherein the audio-image association is a data structure, and wherein the instructions further cause the machine to perform operations comprising: for each image frame of the image frames, storing in the data structure: an identifier of a time instance of the plurality of time instances corresponding to the image frame; an identifier of the image frame; identifiers of a subset of the audio samples corresponding to the image frame based on the ASPIF parameter; a detection result associated with the image frame, the detection result based on the image event; and a detection result associated with each audio sample of the subset of audio samples, the detection result based on the sound event.

In Example 25, the subject matter of Example 24 includes, wherein the detection result associated with the image frame is a type of vehicle detected within the image frame, wherein the detection result associated with each audio sample of the subset of audio samples is a type of vehicle detected based on the audio sample, and wherein the instructions further cause the machine to perform operations comprising: applying a clustering function to the detection results associated with the subset of audio samples to generate a combined detection result associated with the subset of audio samples; and performing data fusion of the detection result associated with the image frame and the combined detection result associated with the subset of audio samples to perform the vehicle recognition.

Example 26 is at least one machine-readable medium including instructions that, when executed by processing circuitry, cause the processing circuitry to perform operations to implement any of Examples 1-25.

Example 27 is an apparatus comprising means to implement of any of Examples 1-25.

Example 28 is a system to implement of any of Examples 1-25.

Example 29 is a method to implement any of Examples 1-25.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A” and “A and B” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A vehicle recognition system comprising:
a microphone arrangement operatively mounted in a vehicle to capture sounds outside of the vehicle;
a sound analysis circuit to analyze the captured sounds using an audio machine learning technique to identify a sound event;
an image capture arrangement operatively mounted in the vehicle to capture images outside of the vehicle;
an image analysis circuit to analyze the captured images using an image machine learning technique to identify an image event; and
a vehicle identification circuit to identify a type of vehicle based on the image event and the sound event.

2. The vehicle recognition system of claim 1, wherein the vehicle identification circuit is configured to:
generate an audio-image association, the audio-image association matching audio samples of the sound event with image frames of the image event for a plurality of time instances;
perform a vehicle recognition to identify the type of vehicle based on the audio-image association; and
transmit a message to a vehicle control system via a vehicle interface, the message based on the vehicle recognition.

3. The vehicle recognition system of claim 2, wherein the image event is detecting a visual representation of a vehicle within at least one of the image frames, and wherein the sound event is detecting a sound associated with the vehicle within at least one of the audio samples.

4. The vehicle recognition system of claim 2, wherein to generate the audio-image association, the vehicle identification circuit is further configured to:
normalize a frame rate of the image frames with a sampling rate of the audio samples to determine an audio samples per image frame (ASPIF) parameter for each time instance of the plurality of time instances.

5. The vehicle recognition system of claim 4, wherein the audio-image association is a data structure and the vehicle identification circuit is further configured to;
for each image frame of the image frames, store in the data structure:
an identifier of a time instance of the plurality of time instances corresponding to the image frame;
an identifier of the image frame;
identifiers of a subset of the audio samples corresponding to the image frame based on the ASPIF parameter;
a detection result associated with the image frame, the detection result based on the image event; and
a detection result associated with each audio sample of the subset of audio samples, the detection result based on the sound event.

6. The vehicle recognition system of claim 5, wherein the detection result associated with the image frame is a type of vehicle detected within the image frame.

7. The vehicle recognition system of claim 6, wherein the detection result associated with each audio sample of the subset of audio samples is a type of vehicle detected based on the audio sample.

8. The vehicle recognition system of claim 7, wherein the vehicle identification circuit is further configured to:
apply a clustering function to the detection results associated with the subset of audio samples to generate a combined detection result associated with the subset of audio samples; and
perform data fusion of the detection result associated with the image frame and the combined detection result associated with the subset of audio samples to perform the vehicle recognition.

9. The vehicle recognition system of claim 2, wherein the vehicle identification circuit is further configured to
generate the message for transmission to the vehicle control system, the message including the type of vehicle.

10. The vehicle recognition system of claim 9, wherein the type of vehicle is a type of emergency vehicle, and wherein the vehicle control system performs a responsive action based on the message indicating the type of emergency vehicle.

11. The vehicle recognition system of claim 10, wherein the responsive action comprises an autonomous vehicle maneuver based on the type of emergency vehicle detected during the vehicle recognition.

12. The vehicle recognition system of claim 1, wherein the audio machine learning technique and the image machine learning technique each comprise an artificial neural network, and wherein identifying the type of vehicle is further based on identifying a light event based on light signals captured outside of the vehicle.

13. A method for vehicle recognition, the method comprising:
capturing sounds outside of a vehicle;
analyzing, by one or more processors of the vehicle, the captured sounds using an audio machine learning technique to identify a sound event;
capturing images outside of the vehicle;
analyzing, by the one or more processors, the captured images using an image machine learning technique to identify an image event; and
identifying, by the one or more processors, a type of vehicle based on the image event and the sound event.

14. The method of claim 13, further comprising:
generating, by the one or more processors, an audio-image association, the audio-image association matching audio samples of the sound event with image frames of the image event for a plurality of time instances;
performing, by the one or more processors, a vehicle recognition to identify the type of vehicle based on the audio-image association; and
transmitting, by the one or more processors, a message to a vehicle control system via a vehicle interface, the message based on the vehicle recognition.

15. The method of claim 13, further comprising:
applying, by the one or more processors, a clustering function to detection results associated with a subset of audio samples to generate a combined detection result associated with the subset of audio samples; and
performing, by the one or more processors, data fusion of a detection result associated with the image frame and the combined detection result associated with the subset of audio samples to perform the vehicle recognition.

16. The method of claim 14, further comprising:
generating, by the one or more processors, the message for transmission to the vehicle control system, the message including the type of vehicle,
wherein the type of vehicle is a type of emergency vehicle, and wherein the vehicle control system performs a responsive action based on the message indicating the type of emergency vehicle.

17. At least one non-transitory machine-readable medium including instructions for vehicle recognition in a vehicle, the instructions when executed by a machine, cause the machine to perform operations comprising:
capturing sounds outside of a vehicle;
analyzing the captured sounds using an audio machine learning technique to identify a sound event;
capturing images outside of the vehicle;
analyzing the captured images using an image machine learning technique to identify an image event; and
identifying a type of vehicle based on the image event and the sound event.

18. The non-transitory machine-readable medium of claim 17, wherein the instructions further cause the machine to perform operations comprising:
generating an audio-image association, the audio-image association matching audio samples of the sound event with image frames of the image event for a plurality of time instances;
performing a vehicle recognition to identify the type of vehicle based on the audio-image association;
transmitting a message to a vehicle control system via a vehicle interface, the message based on the vehicle recognition; and
normalizing a frame rate of the image frames with a sampling rate of the audio samples to determine an audio samples per image frame (ASPIF) parameter for each time instance of the plurality of time instances.

19. The non-transitory machine-readable medium of claim 18, wherein the audio-image association is a data structure, and wherein the instructions further cause the machine to perform operations comprising:
for each image frame of the image frames, storing in the data structure:
an identifier of a time instance of the plurality of time instances corresponding to the image frame;
an identifier of the image frame;
identifiers of a subset of the audio samples corresponding to the image frame based on the ASPIF parameter;
a detection result associated with the image frame, the detection result based on the image event, and
a detection result associated with each audio sample of the subset of audio samples, the detection result based on the sound event.

20. The non-transitory machine-readable medium of claim 19, wherein the detection result associated with the image frame is a type of vehicle detected within the image frame, wherein the detection result associated with each audio sample of the subset of audio samples is a type of vehicle detected based on the audio sample, and wherein the instructions further cause the machine to perform operations comprising:
applying a clustering function to the detection results associated with the subset of audio samples to generate a combined detection result associated with the subset of audio samples; and
performing data fusion of the detection result associated with the image frame and the combined detection result associated with the subset of audio samples to perform the vehicle recognition.
